(19) United States
(12) Patent Application Publication
(10) Pub. No.: US 2005/0211217 A1
(43) Pub. Date: Sep. 29, 2005

(54) Pre-chambered type spark plug with pre-chamber entirely below a bottom surface of a cylinder head

(76) Inventors: William C. Boley, Lafayette, IN (US); Brady L. Winkleman, Lafayette, IN (US); James M. Schultz, Chillicothe, IL (US); Gary P. Mueller, Lafayette, IN (US); Jason L. Niethammer, Geneva (CH)

Correspondence Address: CATERPILLAR INC.;100 N.E. ADAMS STREET, PATENT DEPT., PEORIA, IL, 616296490, US

(21) Appl. No.: 10/806,525

(22) Filed: Mar. 23, 2004

(51) Int. Cl. F02B 19/12; H01T 13/54

(52) U.S. Cl. 123/266; 313/143

(57) ABSTRACT

The present spark plug is of the encapsulated design and facilitates the life of the spark plug, enhances the combustion process and reduces emissions. The position of an ignition chamber of the spark plug is substantially within a combustion chamber of an engine. The configuration of a parabolic end forms the ignition chamber, reduces the heat transferred to the spark plug and increases the life of the spark plug. The configuration or design of the spark plug makes the manufacturing process less costly and facilitates the combustion process by using one of a single orifice or a plurality of orifices positioned at and in a preestablished manner. The configuration will reduce or eliminate pre-ignition and other detonation problems enabling the timing to be advanced further reducing emissions.

### TECHNICAL FIELD

This invention relates generally to a spark ignition device and more particular to a pre-chamber type spark plug.

### BACKGROUND

Emissions and efficiency continue to drive technology to improve combustion of air and fuel mixtures. Many improvements control the air and fuel mixture. Examples of some combustion of air and fuel mixtures improvements include improved combustion chamber design, valve porting and fuel or air flow and atomization process. These improvements all generally improve control of the fuel and air mixture.

Unlike in a diesel cycle engine, spark ignited engines may also control a combustion event through initiation of a spark. Encapsulated spark plugs have shown an improvement gained from improving conditions and mixing of fuel and air along with an improvement gained by controlling initiation of the spark. The encapsulated spark plug includes a plug shell surrounding an electrode gap. The plug shell defines an ignition chamber separated from a combustion chamber. An orifice or orifices are positioned in the plug shell interconnecting the ignition chamber with the combustion chamber. The ignition chamber and the plug shell separate a flame kernel from turbulence in the combustion chamber. As a piston compresses and air and fuel mixture within the combustion chamber, at least a portion of the air and fuel mixture passes through the orifices into the ignition chamber.

In the ignition chamber, a spark causes the air and fuel mixture to combust creating a pressure rise. As the pressure in the ignition chamber increases and overcomes the pressure within the combustion chamber, hot gasses pass through each orifice into the combustion chamber and act as an ignition torch increasing the combustion rate in the combustion chamber to reduce the masses of unburned air and fuel mixture. U.S. Pat. No. 5,105,780 issued on Apr. 21, 1992 to Ronald D. Richardson defines one such encapsulated spark plug.

Although the encapsulated spark plug has been shown to increase efficiency and reduce emissions other drawbacks tend to reduce their use. For example, the encapsulated spark plug experiences an increased temperature environment, thus, reducing its detonation margin over a conventional spark plug. The encapsulated spark plug which protrudes into the combustion chamber has been know to causes pre-ignition and other detonation problems. In a lean air and fuel mixture the voltage needed to jump an electrode gap between an electrode and ground electrode required results in an increased voltage due to break down in the voltage. The increased break down voltages requires a greater electrical insulation between the electrode and ground electrode. The increased electrical insulation often means increasing a heat transfer path between a capsule connected to the ground electrode and cool environment. Further exacerbating wear, the orifices through the plug shell experience extreme temperature changes. Hot gas exits the ignition chamber through the orifices at high velocities. These high velocities increase heat transfer from the hot gases to the plug shell decreasing life of the encapsulated spark plug. Additionally, resistance such as welds used to attach the plug shell to the plug hinders heat transfer away from the orifices.

The present invention is directed to overcoming one or more of the problems as set for the above.

### SUMMARY OF THE INVENTION

In one aspect of the present invention, a spark ignited engine is comprised of a block having a top surface and a cylindrical bore therein; a piston is movably positioned in the cylindrical bore; a cylinder head having a bottom surface and is attached to the block; a combustion chamber is defined by the cylindrical bore, the piston and the bottom surface of the cylinder head. A spark plug has an electrode, a plug shell, a tip and orifice portion defining a bottom portion, and an insulator. A portion of the spark plug is positioned in the cylinder head. The spark plug is of an encapsulated configuration and defines an ignition chamber having a cocoon configuration; and the ignition chamber of the spark plug is substantially positioned within the combustion chamber substantially external of the cylinder head.

In another embodiment of this invention, a spark plug is comprised of an electrode being an electrical conductor and having a heat resistance; an insulator being operatively positioned about the electrode and maintaining structural integrity in a high temperature environment; a plug shell being operatively connected to the electrode and having an insulator region, a connection region and a tip and orifice portion, the tip and orifice portion having an ignition chamber therein defining a cocoon configuration; and the ignition chamber of the spark plug being substantially positioned within said combustion chamber substantially external of the cylinder head.

### BRIEF DESCRIPTION OF THE DRAWINGS

FIG. 1 is a cross section view of a spark ignited internal combustion engine having a spark plug positioned therein;

FIG. 2 is an enlarged partially cross sectioned view of a spark plug having an embodiment of the present invention;

FIG. 3 is a sectional view of the spark plug of FIG. 2 taken along line 3-3;

FIG. 4 is an enlarged partially cross sectioned view of a spark plug having an embodiment of the present invention;

FIG. 5 is a sectional view of the spark plug of FIG. 4 taken along line 5-5;

FIG. 6 is a sectional view of another alternative spark plug;

FIG. 7 is a sectional view of another alternative spark plug; and

FIG. 8 is a sectional view of another alternative spark plug.

### DETAILED DESCRIPTION

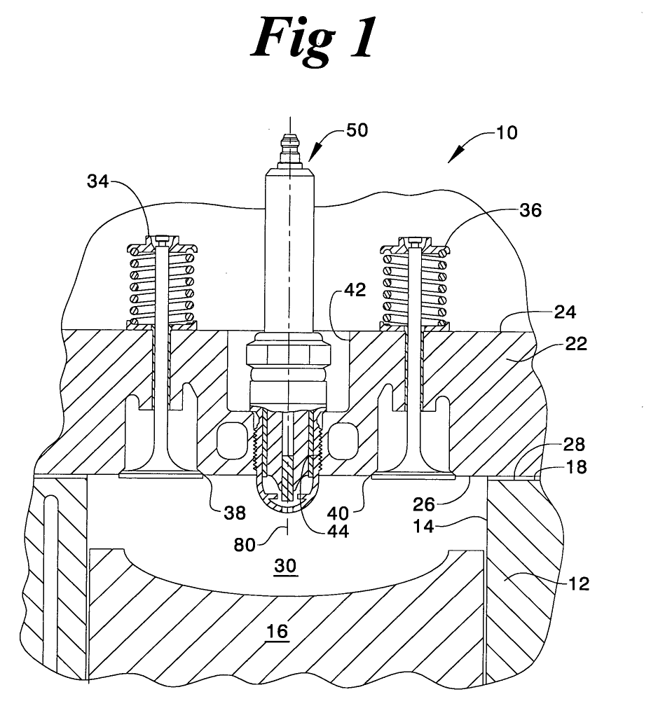

In FIG. 1, a spark ignition engine 10 is partially shown. The engine 10 includes a block 12 having a cylinder bore 14 therein. A piston 16 of conventional design is movably positioned within the cylinder bore 14 in a conventional manner. The block 12 defines a top surface 18.

A cylinder head 22 defines a top surface 24 and a bottom surface 26. The bottom surface 26 of the cylinder head 22 is removably attached to the top surface 18 of the block 12 in a conventional manner such as by a plurality of bolts, not shown. A gasket 28 is normally interposed the top surface 18 of the block 12 and the bottom surface 26 of the cylinder head 22. Thus, a combustion chamber 30 is defined between the bottom surface 26 of the cylinder head, the cylinder bore 14 of the block and the piston 16. The cylinder head 22 has at least one intake valve mechanism 34 operatively positioned therein and at least one exhaust valve mechanism 36 operatively positioned therein. An intake sealing portion 38 of the intake valve mechanism 34 is positioned near the bottom surface 26. And, an exhaust sealing portion 40 of the exhaust valve mechanism 36 is positioned near the bottom surface 26. In this application, the intake valve mechanism 34 and the exhaust valve mechanism 36 are operated by a cam, follower and push rod mechanism, not shown. The intake valve mechanism 34 and the exhaust valve mechanism 36 could be operated by other means such as hydraulic or electrical without changing the gist of the design. A stepped through bore 42 is positioned in the cylinder head 22 and extends between the top surface 24 and the bottom surface 26. With the cylinder head 22 positioned on the block and in this application, the stepped through bore 42 is centered about the cylinder bore 14. As an alternative, the stepped through bore 42 could be positioned in any manner about the cylinder bore 14. The stepped through bore 42 includes a fastening mechanism 44 of conventional design, such as a threaded portion or a wedge portion.

As further shown in FIG. 2, a spark plug 50 or sparking means or means for igniting a combustible mixture is positioned in the stepped through bore 42. In this application, the spark plug 50 is of the encapsulated design. The spark plug 50 has a connecting portion 52 or connecting means which in this application is a threaded connector. The connecting portion 52 and the fastening mechanism 44 of the stepped through bore 42 must be capable of withstanding pressure, temperature and chemistry compatibility typical of a combustion process. The spark plug 50 is sealingly connected with the cylinder head 22 in a conventional manner.

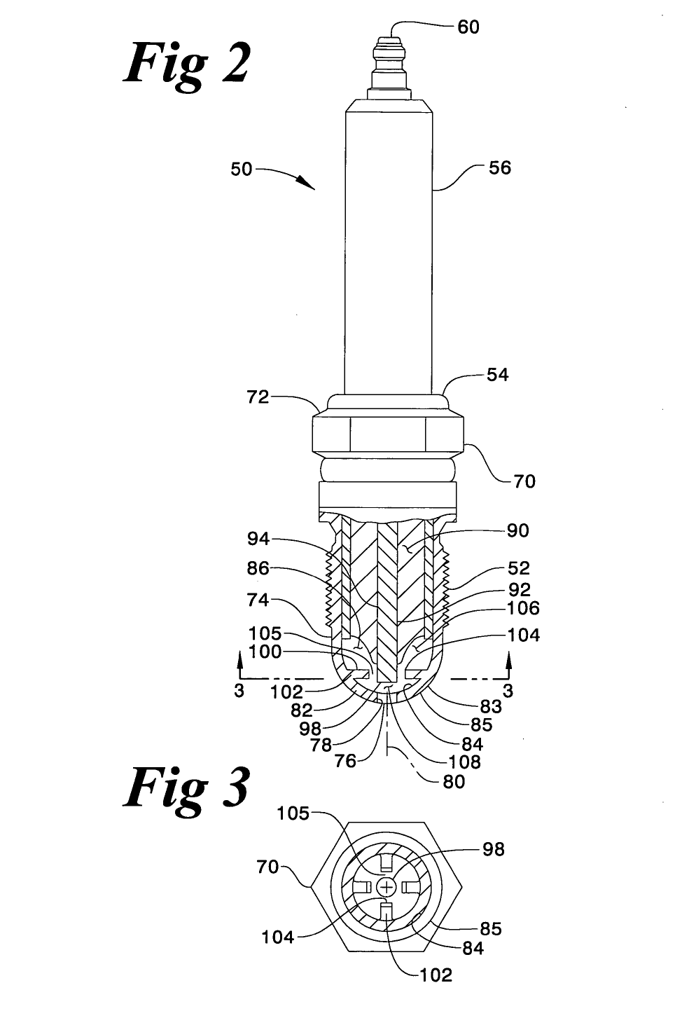

In FIG. 2, the spark plug 50 is shown partially sectioned and at a larger scale. The spark plug 50 includes an insulator retention region 54, insulator 56, and a terminal 60. The terminal 60 can also be a means for conducting an electrical discharge. And, the insulator 56 can be a means for insulating. The terminal 60 is made of a material having good electrical conductivity and heat resistance such as a nickel alloy. The insulator 56 operatively electrically isolates the terminal 60 and maintains structural integrity in a high temperature environment. One such material for making the insulator 56 is a ceramic material. The insulator 56 connects and covers the terminal 60. The insulator retention region 54 has plug shell 70, a connection region 72, and a tip and orifice portion 74. The tip and orifice portion 74 has at least one orifice 76 therein. For example, as shown in FIG. 2, a single orifices 78 is shown. The single orifice 78, in this application, has an axis, designated by a reference numeral 80, which is axially aligned with an axis of the cylindrical bore 14 of the block 12. The single orifice 78 has a preestablished size. Another diameter or size can be used without departing from the essences of the design. The tip and orifice portion 74 defines a bottom portion 82 which with the spark plug 50 positioned in the cylinder head 22 is partially aligned below the bottom surface 26 of the cylinder head. The bottom portion 82 of the spark plug 50 in this application forms a cocoon having an oval configuration or has a parabolic end 83 which extends beyond the bottom surface 26 of the cylinder head 22 into the combustion chamber 30. As shown in FIG. 3, the parabolic end 83 has an inside surface 84 and an outside surface 85. Within the bottom portion 82 and formed by the cocoon is an ignition chamber 86. Thus, the bottom portion 82 the insulator retention region 54 and the insulator 56 form a means for defining the ignition chamber 86. The insulator retention region 54 is made from a material having high thermal conductivity, high thermal stability, and resistance to environmental corrosion. Similarly, corrosion resistant surface treatments may provide corrosion resistance.

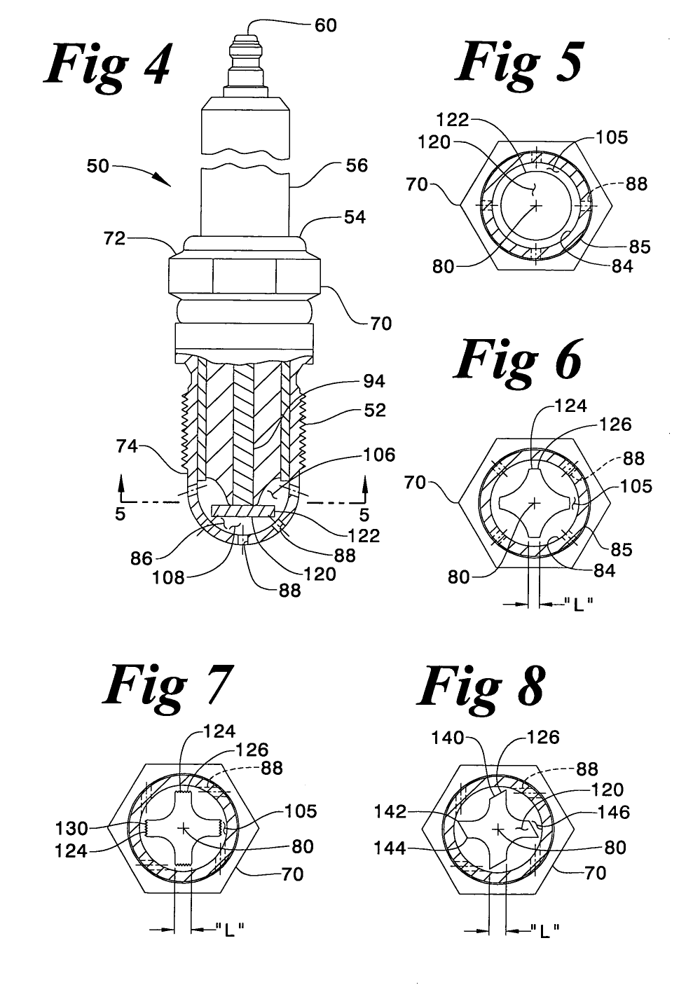

As an alternative, the tip and orifice portion 74 could have more than at least one orifice 76. For example, as shown in FIGS. 4, 5, 6, and 7, a plurality of orifices 88 are shown. In this application four orifices are shown having a preestablished size. Another diameter or size or quantity can be used without departing from the essences of the design. In FIG. 4, each individual one of the plurality of orifices 88 are equally spaced from the axis 80 in a conical manner. The apex of the conical centerline being at or below the terminal 60.

As shown in FIG. 2, a lower part 90 of the ceramic insulator 56 includes a pin portion 92 and an element 94 which may be one piece or may include a resistor therebetween, not shown. As a further alternative, the terminal/resistor/electrode 60 may be part of the ceramic insulator mold. A preestablished axial position is designated by the reference numeral 98. A plurality of grounding members 100 are attached to the tip and orifice portion 74. Each of the plurality of grounding members 100 has an attaching end portion 102 and an electrode end portion 104. The attaching end portion 102 is fixedly attached to the inside surface 84 of the parabolic end 83. And, the electrode end portion 104 forms a gap 105 having a preestablished distance. The plurality of grounding members 100 divide the ignition chamber 86 into a back side portion 106 and a front side portion 108. The front side portion 108 is positioned nearest to the piston 16 and the back side portion 106 is positioned furthest away from the piston 16. A portion of the plurality of orifices 88 open into the back side portion 106 and a portion of the plurality of orifices 88 open into the front side portion 108 of the ignition chamber 86.

In FIG. 4, the lower part 90 has a plate member 120 attached thereto. In this application, the plate member 120 defines a perimeter 122 which has a cylindrical configuration as is best shown in FIG. 5. The plate member 120 divides the ignition chamber 86 into the back side portion 106 and the front side portion 108. The perimeter 122 is spaced from the inside surface 84 a preestablished distance forming the gap 105. A portion of the plurality of orifices 88 open into the back side portion 106 and a portion of the plurality of orifices 88 open into the front side portion 108 of the ignition chamber 86.

The perimeter 122 of the plate member 120 may have a plurality of configuration. For example in FIGS. 6 and 7, the plate member 120 defines a plurality of tip portions 124. In this application, four tip portions are formed along the perimeter 122 and are equally spaced apart and have a tip 126 defining a preestablished length “L”. In this application the length “L” of each of the tip lengths “L” is equal. However, as an alternative, the number of tips 126 and the length “L” of each tip 126 could be varied. Additionally, the length “L” of each of the tips 126 may be of unequal lengths. The plurality of orifices 88 shown in are elevationally aligned with that of the corresponding one of the tip 126.

In FIG. 7, the length “L” of the tip 126 has a serrated configuration 130. And, as shown, the plurality of orifices 88 may be radially positioned with respect to the axis 80. And, the plurality of orifices 88 shown in are elevationally aligned with that of the tip 126 and aligned generally with that of the gap 105.

In FIG. 8, the tip 126 has a tapered configuration 140. For example, a first edge 142 of the tip 126 is spaced from the inside surface 84 a preestablished distance and a second edge 144 is spaced from the inside surface 84 a preestablished distance being greater than the preestablished distance of the first edge 142. Thus, forming a tapered gap 146. The plurality of orifices 88 are elevationally aligned with that of the tip 126 and are aligned generally with that of the gap 146.

In this application, the ignition chamber 86 has a preestablished chamber volume. However, depending on the displacement of the combustion chamber 30 the chamber volume of the ignition chamber 86 will be optimized or varied. A larger combustion chamber 30 will have a larger ignition chamber 86 volume and a smaller combustion chamber 30 will have a smaller ignition chamber 86 volume. In this application, the tip and orifice portion 74 is connected to the plug shell 70 by a full depth conventional TIG welding process. Other conventional connection methods such as brazing may also be used so long as the resulting method withstands the high temperature and high pressure environment. For example, the tip and orifice portion 74 may be connected to the plug shell 70 by a press fit or threadedly connected. The tip and orifice portion 74 may be made from a second material having high thermal conductivity, high thermal stability, and resistance to environmental corrosion in high temperatures up to 1150 C. In this application, the first material and second material are the same. However, the first material and the second material may be different without changing the gist of the spark plug 50.

Other configurations of the contours making up the above plug shell could be used without changing the gist of the invention; however, in this application the configurations as defined are intended to enhance the manufacturing process, increase the longevity of the spark plug 50 and reduce emission emitted from the engine 10. Experimentation has shown that the configuration will reduce or eliminate pre-ignition and other detonation problems enabling the timing to be advanced further optimizing engine performance.

### INDUSTRIAL APPLICABILITY

In operation, the spark plug 70 is positioned in the cylinder head 22. In this application, the spark plug 50 is threadedly attached with the fastening mechanism 44 of the cylinder head 22. The plug shell 70 is substantially positioned in the cylinder head 22 and the bottom portion 82 of the tip and orifice portion 74, containing the ignition chamber 86, extends into the combustion chamber 30 of the engine 10.

With the position of the spark plug 50 bottom portion 82 substantially within the combustion chamber 30 heat from the combustion within the combustion chamber 30 is transferred to the plug shell 70 of the spark plug 50. However, with the parabolic configuration of the bottom portion 82 heat which was transferred from the combustion process, is more easily dissipated and with the elimination of corners the structural integrity of the spark plug is increased with the parabolic end 83. Thus, the life of the spark plug 50 is extended. Experimentation has shown that the configuration will reduce or eliminate pre-ignition and other detonation problems enabling the timing to be advanced even further optimizing engine performance.

The configuration of the spark plug 50 enhances operation of the engine 10. For example, the parabolic end 83 configuration of the bottom portion 82 improves heat transfer and improves outlet flow from the ignition chamber 86 to the combustion chamber 30. The cocoon configuration helps to purge combustion gas and eliminates trapped combustion gas. The routing of a portion of the plurality of orifices 88 into the back side portion 106 of the ignition chamber 86 helps to eliminate trapped combustion gas, aids in mixing and assists in purging of gases from the previous firing event. Additionally, the design of multiple ignition locations increases the number of spark jump points, thus insuring ignition and combustion within the cocoon configuration. And, with the bottom portion 82 embedded within the combustion chamber 30 the speed of the combustion process will be increased. With the orientation of the plurality of orifices 88, swirling within the ignition chamber 86 is enhanced. With the terminal 60 located close to the center or along the axis 80, the start of combustion is advanced improving engine performance. The configuration will allow for a variation in gap 105, 146 settings. And, with a tapered gap 146, the spark will travel from the narrow end or first edge 142 toward the wider end or second edge 144, thus exposing the spark to a greater area as well as lengthen the gap 105,146, improving combustion. Causing the spark to travel longer will also improve electrode life. And, the serrated tip 130 will lower firing voltage and improve ignition system life. With the plurality of orifices 88 being elevationally aligned with the gap 105, 146 the incoming combustion air, air and fuel, will cause a swirling effect. In the configuration shown in FIG. 8, the incoming combustion air will blow on the electrode gap from the narrow portion of the gap 146 to the wider portion of the gap 146 causing the arc to travel. The travel effect will cause less electrode wear and may result in a more even wear as well as exposing the arc to more combustion creating better starting at ignition. The taper having the small gap portion allows for a smaller spark voltage. The taper gap also results in the physical spark being able to grow as the spark is being blown toward the larger gap portion like a Jacob's Ladder.

The construction of the plug shell 70 of the spark plug 50 makes for easy manufacturing reducing cost and enhances the combustion process reducing emissions. For example, with the bottom portion 82 and the connection portion 72 being separate components the manufacturing process is enhanced. As an alternative, however, the components could be made from one piece and the welding process eliminated.

Thus, the embodiment of the present spark plug 50 enhances the manufacturing of the spark plug 50, the longevity of the spark plug 50 and the efficiency of the resulting ignition of the combustion chamber 30 reducing emissions. And, experimentation has shown that the configuration will reduce or eliminate pre-ignition and other detonation problems enabling the timing to be advanced further reducing emissions.

Other aspects, objects and advantages of this invention can be obtained from a study of the drawings, the disclosure, and the appended claims.

1. A spark ignited engine; said engine comprising:
a block having a top surface and a cylindrical bore therein;
a piston being movably positioned in said cylindrical bore;
a cylinder head having a bottom surface and being attached to said block;
a combustion chamber being defined by said cylindrical bore, said piston and said bottom surface of said cylinder head;
a spark plug having an electrode, a plug shell, a tip and orifice portion defining a bottom part, and an insulator, a portion of said spark plug being positioned in said cylinder head;
said spark plug being of an encapsulated configuration defining an ignition chamber having a cocoon configuration; and
said ignition chamber of said spark plug being substantially positioned within said combustion chamber substantially external of said cylinder head.

2. The spark ignited engine as defined in claim 1 wherein said bottom part of said tip and orifice portion defines a parabolic end.

3. The spark ignited engine as defined in claim 1 wherein said ignition chamber defines a backside portion and a front side portion.

4. The spark ignited engine as defined in claim 1 wherein said ignition chamber has at least a single orifice exiting therefrom into said combustion chamber.

5. The spark ignited engine as defined in claim 4 wherein said single orifice is positioned about an axis, said axis being aligned with an axis of said combustion chamber.

6. The spark ignited engine as defined in claim 1 wherein said ignition chamber has a plurality of orifices exiting therefrom into said combustion chamber.

7. The spark ignited engine as defined in claim 6 wherein said plurality of orifices are position about an axis, said axis being aligned with an axis of said combustion chamber.

8. The spark ignited engine as defined in claim 1 wherein said ignition chamber defines a backside portion and a front side portion and a portion of said plurality of orifices exit said backside portion into said combustion chamber.

9. The spark ignited engine as defined in claim 8 wherein another portion of said plurality of orifices exits said front side portion into said combustion chamber.

10. The spark ignited engine as defined in claim 1 wherein said electrode includes a pin portion being attached in a preestablished axial position.

11. The spark ignited engine as defined in claim 10 wherein said cocoon configuration has a parabolic end having an inside surface and having a plate member attached thereto, said plate member defining a perimeter being spaced from said inside surface and defining a gap.

12. The spark ignited engine as defined in claim 11 wherein said perimeter of said plate member having a cylindrical configuration.

13. The spark ignited engine as defined in claim 11 wherein said perimeter of said plate member defining a plurality of tip portions.

14. The spark ignited engine as defined in claim 13 wherein said plurality of tip portions define a serrated configuration.

15. The spark ignited engine as defined in claim 13 wherein said plurality of tip portions define a tapered configuration.

16. A spark plug comprising:
an electrode being an electrical conductor and having a heat resistance;
an insulator being operatively positioned about the electrode and maintaining structural integrity in a high temperature environment;
a plug shell being operatively connected to the electrode and having an insulator region, a connection region and a tip and orifice portion, said tip and orifice portion having an ignition chamber therein defining a cocoon configuration; and
said ignition chamber of said spark plug being substantially positioned within said combustion chamber substantially external of said cylinder head.

17. The spark plug as defined in claim 16 wherein said bottom portion of said tip and orifice portion defines a parabolic end.

18. The spark plug as defined in claim 16 wherein said ignition chamber defines a back side portion and a front side portion.

19. The spark plug as defined in claim 16 wherein said ignition chamber has at least a single orifice exiting therefrom.

20. The spark plug as defined in claim 19 wherein said opening is positioned about an axis.

21. The spark plug as defined in claim 16 wherein said ignition chamber has a plurality of orifices exiting therefrom.

22. The spark plug as defined in claim 16 wherein said ignition chamber defines a back side portion and a front side portion and a portion of said plurality of orifices exit said backside portion.

23. The spark plug as defined in claim 22 wherein another portion of said plurality of orifices exit said front side portion.

24. The spark plug as defined in claim 16 wherein said electrode includes a pin portion being attached in a preestablished axial position.

25. The spark ignited engine as defined in claim 16 wherein said cocoon configuration has a parabolic end having an inside surface and having a plate member attached thereto, said plate member defining a perimeter being spaced from said inside surface and defining a gap.

26. The spark ignited engine as defined in claim 25 wherein said perimeter of said plate member having a cylindrical configuration.

27. The spark ignited engine as defined in claim 25 wherein said perimeter of said plate member defining a plurality of tip portions.

28. The spark ignited engine as defined in claim 25 wherein said plurality of tip portions define a serrated configuration.

29. The spark ignited engine as defined in claim 25 wherein said plurality of tip portions define a tapered configuration.
